(19) United States
(12) Patent Application Publication
(10) Pub. No.: US 2026/0226710 A1
(43) Pub. Date: Aug. 6, 2026

(54) MOBILE MACHINE WITH IMPROVED ELECTRIC POWERED ACTUATOR SYSTEM

(71) Applicant: Moog Inc., East Aurora, NY (US)

(72) Inventor: David Geiger, Hamburg, NY (US)

(21) Appl. No.: 19/147,831

(22) PCT Filed: Jan. 17, 2024
(86) PCT No.: PCT/US2024/011796

§ 371 Date: Jul. 14, 2025

Related U.S. Application Data
(60) Provisional application No. 63/440,062, filed on Jan. 19, 2023.

(51) Int. Cl. E02F 9/22; E02F 9/20; F15B 1/027; F15B 15/12

(52) U.S. Cl. CPC E02F 9/2203; E02F 9/2095; E02F 9/2217; E02F 9/2267; E02F 9/2271; E02F 9/2275; E02F 9/2292; F15B 1/027; F15B 15/12; E02F 9/2285; E02F 9/2296

(57) ABSTRACT

A mobile machine comprising an electric power source connected to an actuator motor and a charge motor, an actuator pump driven by the actuator motor and a charge pump driven by the charge motor, a hydraulic actuator connected the actuator pump by a control line, a tank open to atmosphere, and the charge pump connected to the tank and connected to the control line by a charge line, wherein a machine tool is operatively controllable by the actuator motor and a charge pressure in the charge line is operatively controllable by the charge motor. A second hydraulic actuator may be connected to the actuator pump via the control line and a valve assembly may be in the control line between the actuator pump and each of the first and second actuators to control flow therebetween, wherein the actuator motor and valve assembly alternatively control the first and second actuators.

### TECHNICAL FIELD

The present disclosed subject matter relates generally to the field of mobile machines, and more particularly to a mobile machine with an improved electric powered actuator system.

### BACKGROUND

Mobile machines are generally land vehicles with attached machinery or equipment that are self-propelled or mobile and that, in contrast to automobiles, provide functionality beyond conveying people from one point to another. Mobile machines are known to include, without limitation, forklifts, skid steers, excavators, tractors, earthmovers, farm machinery, dump trucks, garbage trucks, mobile cranes, and other mobile construction equipment. Lift arm mobile machines are generally self-propelled construction vehicles that have one or more lift arms that support and actuate attached work tools or attachments, such as for example skid steer loaders, forklifts, excavators, and tractors.

### BRIEF SUMMARY

With parenthetical reference to the corresponding parts, portions or surfaces of the disclosed embodiment, merely for purposes of illustration and not by way of limitation, an improved mobile machine (16) is provided comprising: an object (18) configured to be driven relative to a body portion (17) of the mobile machine; an electric power source (19); an electric actuator motor (52a, 52b) connected to the electric power source and configured to be supplied with a current; an actuator pump (53a, 53b) driven by the actuator motor; a hydraulic actuator (20a, 20b, 21a, 21b, 22, 120, 220) connected the actuator pump by a hydraulic control line (33, 34, 35, 36, 37, 38, 37a, 38a); the hydraulic actuator configured to actuate the object to be driven relative to the mobile machine within a range of motion; a tank (30) open to atmosphere; an electric charge motor (72) connected to the electric power source and configured to be supplied with a current; a charge pump (73) driven by the charge motor; the charge pump connected to the tank and connected to the hydraulic control line by a charge line (74, 74a, 74b, 74c, 74d; 75, 75a, 75b, 75c, 75d, 174, 174a, 174b, 174c, 174d, 175, 175a, 175b, 175c, 175d); wherein actuation of the object to be driven relative to the body portion of the mobile machine within the range of motion is operatively controllable by the actuator motor; and wherein a charge pressure in the charge line is operatively controllable by the electric charge motor.

The hydraulic actuator may comprise a housing (24a, 24b, 24c, 24d, 24e, 124, 224) having a first hydraulic port (29a, 29c, 29e, 29g, 29i, 129a, 229a) and a second hydraulic port (29b, 29d, 29f, 29h, 29j, 129b, 229b); the control line may comprise a first control line (33, 35, 37, 37a) between the actuator pump and the first port and a second control line (34, 36, 38, 38a) between the actuator pump and the second port; and the charge line may be connected to the first control line and the second control line.

The hydraulic actuator may comprise a linear hydraulic actuator (20a, 20b, 21a, 21b, 22) or a rotary hydraulic actuator (120, 220). The hydraulic actuator may comprise a linear hydraulic actuator (20a, 20b, 21a, 21b, 22); the housing (24a, 24b, 24c, 24d, 24e) may comprise a first hydraulic chamber (25a, 25b, 25c, 25d, 25e) and a second hydraulic chamber (26a, 26b, 26c, 26d, 26e); the first control line (33, 35, 37) may be between the actuator pump and the first chamber and the second control line (34, 36, 38) may be between the actuator pump and the second chamber; the linear hydraulic actuator may comprise a hydraulic piston (27a, 27b, 27c, 27d, 27e) between the first hydraulic chamber and the second hydraulic chamber and an actuating rod (28a, 28b, 28c, 28d, 28e) connected to the piston and configured to translate along an axis with movement of the piston relative to the housing; and one of the housing or the actuating rod may be connected to the mobile machine and the other of the housing or the actuating rod may be connected to the object to be driven. The hydraulic actuator may comprise a rotary hydraulic actuator; the rotary hydraulic actuator may comprise a hydraulic motor (120, 220): the hydraulic motor may comprise a hydraulic rotary element (127, 227) between the first (129a, 229a) and second ports (129b, 229b) of the housing (124, 224) and an actuating shaft connected to the rotary element and configured to rotate about an axis with movement of the rotary element relative to the housing; and one of the housing or the actuating shaft may be connected to the mobile machine and the other of the housing or the actuating shaft may be connected to the object to be driven. The hydraulic motor may be selected from a group consisting of a vane-type hydraulic motor, a radial-piston type hydraulic motor, an axial-piston type hydraulic motor, and a gear-type hydraulic motor.

The mobile machine may comprise a hydraulic release (54a, 55a, 44a, 44b, 54b, 55b, 45a, 45b) between the control line and the charge line. The mobile machine may comprise a hydraulic release (54a, 55a, 54b, 55b) between the control line (33, 34, 35, 36) and the charge line (74a, 74d. 75a, 75d, 174a, 174d, 175a, 175b) and between the actuator pump and the hydraulic actuator and the hydraulic release may be operatively configured to release hydraulic fluid from the first control line (33, 35) or the second control line (34, 36) when a control pressure in the first control line or the second control line exceeds a threshold value. The hydraulic release may comprise: a first release valve (54a, 54b) between the first hydraulic port (29a, 29c, 29e, 29g, 129a) and the actuator pump and between the first control line (33, 35) and the charge line (74d, 75d, 174d, 175d); and a second release valve (55a, 55b) between the second hydraulic port (29b, 29d, 29f, 29h, 129b) and the actuator pump and between the second control line (34, 36) and the charge line (74a, 75a, 174a, 175a). The hydraulic release (54a, 55a, 54b, 55b) may comprise a first check valve between the first hydraulic port and the second release valve, and a second check valve between the second hydraulic port and the first release valve. The mobile machine may comprise a first check valve (44a, 45a) between the first control line (33, 35) and the charge line (74b, 75b, 174b, 175b) and a second check valve (44b, 45b) between the second control line (34, 36) and the charge line (74c, 75c, 174c, 175c). The mobile machine may comprise: a first valve (54a, 54b) between the first control line (33, 35) and the charge line (74d, 75d, 174d, 175d); a second valve (54b, 55b) between the second control line (34, 36) and the charge line (74a, 75a, 174a, 175a); a third valve (44a, 45a) between the first control line (33, 35) and the charge line (74d, 75d, 174d, 175d); a fourth valve (44b, 45b) between the second control line (34, 36) and the charge line (74c, 75c, 174c, 175c).

The mobile machine may comprise a hydraulic accumulator (170) connected to the charge line (174) between the charge pump (73) and the hydraulic control line (33, 34) and wherein a base pressure in the charge line may be operatively controllable by the hydraulic accumulator. The hydraulic accumulator may be selected from a group consisting of a diaphragm type accumulator, a piston type accumulator, and a spring type accumulator.

The mobile machine may comprise: a coolant input line (91, 91a, 91b, 191) connected to the actuator pump (53a, 53b) and connected to the charge line (74, 75, 174, 175) between the charge pump (73) and the hydraulic control line (33, 34, 35, 36); and a coolant output line (92, 92a, 92b, 192) connected to the actuator pump (53a, 53b) and connected to the tank (30).

The mobile machine may comprise a relief valve (46) connected to the charge line (74, 75, 174, 175) between the charge pump (73) and the hydraulic control line (33, 34, 35, 36) and connected to the tank (30). The relief valve may comprise a one-way check valve.

The mobile machine may comprise a controller (60) that receives input signals and outputs command signals to the electric charge motor. The mobile machine may comprise a pressure sensor (81) configured to sense the charge pressure of the charge line (74, 75) and to provide a charge pressure input signal to the controller. The electric charge motor (72) may be operatively controlled by the controller based on the charge pressure input signal so as to operatively maintain a minimum threshold charge pressure of the charge line.

The mobile machine may comprise: a second electric actuator motor (52a, 52b) connected to the electric power source and configured to be supplied with a current; a second pump (53a, 53b) driven by the second actuator motor; a second hydraulic actuator (20a, 20b, 21a, 21b, 22, 120, 220) connected to the second pump by a second hydraulic control line (33, 34, 35, 36, 37, 38, 37a, 38a); the second hydraulic actuator configured to actuate a second object (18) to be driven relative to the mobile machine within a second range of motion; the charge pump connected to the second hydraulic control line by the charge line; and wherein actuation of the second object to be driven relative to the body portion of the mobile machine within the second range of motion may be operatively controllable by the second actuator motor and powered via the electric power source. The range of motion may comprise rotational motion about a tilt axis and the second range of motion may comprise translational motion along a lift axis. The mobile machine may comprise a skid steer loader (16) and the object to be driven and the second object to be driven may comprise a bucket (18) configured to be lifted and tilted relative to the body portion (17) of the mobile machine.

The actuator motor may be a variable speed bidirectional electric motor adapted to operatively provide a torque on the output shaft at varying speeds and by direction, the hydraulic pump may be a reversible variable speed hydraulic pump, and actuation of the object to be driven relative to the body portion of the mobile machine within the range of motion may be controllable by adjusting the speed and/or direction of the variable speed bidirectional electric motor. The electric charge motor may comprise a brushless DC servomotor. The hydraulic pump and the charge pump may be selected from a group consisting of a fixed displacement pump, a variable displacement pump, a two-port pump, and a three-port pump.

The mobile machine may comprise: a second hydraulic actuator (22, 220) connected the actuator pump (53b) by the hydraulic control line (35, 36, 37, 38, 37a, 38a); the second hydraulic actuator configured to actuate a second object to be driven relative to the mobile machine within a second range of motion; and a valve assembly (58b, 59b, 58c, 59c, 58d, 59d) in the hydraulic control line between the actuator pump and each of the hydraulic actuator and the second hydraulic actuator and configured to control flow between the actuator pump and each of the hydraulic actuator and the second hydraulic actuator; wherein actuation of the object to be driven relative to the body portion of the mobile machine within the first range of motion may be operatively controllable by the actuator motor and the valve assembly and alternatively actuation of the second object to be driven relative to the body portion of the mobile machine within the second range of motion may be operatively controllable by the actuator motor and the valve assembly.

In another aspect, a mobile machine is provided comprising: an electric power source (19); an electric actuator motor (52b) connected to the electric power source and configured to be supplied with a current; an actuator pump (53b) driven by the actuator motor; a first hydraulic actuator (21a, 21b, 120) connected to the actuator pump; the first hydraulic actuator configured to actuate a first object to be driven relative to the mobile machine within a first range of motion; a second hydraulic actuator (22, 220) connected to the actuator pump; the second hydraulic actuator configured to actuate a second object to be driven relative to the mobile machine within a second range of motion; a hydraulic control line (35, 36, 37, 38, 37a, 38a) between the actuator pump and both the first hydraulic actuator and the second hydraulic actuator; and a valve assembly (58b, 59b, 58c, 59c, 58d, 59d) in the hydraulic control line between the actuator pump and each of the first and second hydraulic actuators and configured to control flow between the actuator pump and each of the first and second hydraulic actuators; wherein actuation of the first object to be driven relative to the body portion of the mobile machine within the first range of motion may be operatively controllable by the actuator motor and the valve assembly and alternatively actuation of the second object to be driven relative to the body portion of the mobile machine within the second range of motion may be operatively controllable by the actuator motor and the valve assembly.

The valve assembly may comprise a four way valve. The first hydraulic actuator may comprise a first housing (24c, 24d, 124) having a first port (29e, 29g, 129a) and a second port (29f, 29h, 129b); the control line may comprise a first control line (35) between the actuator pump and the first port and a second control line (36) between the actuator pump and the second port; the valve assembly may comprise a first valve (58b) in the first control line between the actuator pump and the first port configured to control flow between the actuator pump and the first port; the valve assembly may comprise a second valve (50b) in the second control line between the actuator pump and the second port configured to control flow between the actuator pump and the second port; the second hydraulic actuator may comprise a second housing (24e, 224) having a third port (29i, 229a) and a fourth port (29j, 229b); the control line may comprise a third control line (37, 37a) between the actuator pump and the third port and a fourth control line (38, 38a) between the actuator pump and the fourth port; the valve assembly may comprise a third valve (58c, 58d) in the third control line between the actuator pump and the third port configured to control flow between the actuator pump and the third port; and the valve assembly may comprise a fourth valve (59c, 59d) in the fourth control line between the actuator pump and the fourth port configured to control flow between the actuator pump and the fourth port.

The first and second hydraulic actuators may each comprise a linear hydraulic actuator (21a, 21b, 22) or a rotary hydraulic actuator (120, 220). The first hydraulic actuator may comprise a linear hydraulic actuator (21a, 21b); the first housing (24c, 24d) may comprise a first hydraulic chamber (25c, 25d) and a second hydraulic chamber (26c, 26d); the first control line (35) may be between the actuator pump and the first chamber and the second control line (26) may be between the actuator pump and the second chamber; the first linear hydraulic actuator may comprise a first hydraulic piston (27c, 27d) between the first hydraulic chamber and the second hydraulic chamber and an actuating rod (28c, 28d) connected to the piston and configured to translate along an axis with movement of the piston relative to the housing; and one of the housing or the actuating rod may be connected to the mobile machine and the other of the housing or the actuating rod may be connected to the object to be driven. The second hydraulic actuator may comprise a rotary hydraulic actuator and the rotary hydraulic actuator may comprise a hydraulic motor (220): the hydraulic motor may comprise a hydraulic rotary element (227) between the third (229a) and fourth ports (229b) of the second housing (224) and an actuating shaft connected to the rotary element and configured to rotate about an axis with movement of the rotary element relative to the housing; and one of the second housing or the actuating shaft may be connected to the mobile machine and the other of the housing or the actuating shaft may be connected to the object to be driven. The hydraulic motor may be selected from a group consisting of a vane-type hydraulic motor, a radial-piston type hydraulic motor, an axial-piston type hydraulic motor, and a gear-type hydraulic motor. The first, second, third and fourth valves may each comprise a solenoid valve.

The mobile machine may comprise: a third hydraulic actuator (22, 220) connected to the actuator pump; the third hydraulic actuator may be configured to actuate a third object to be driven relative to the mobile machine within a third range of motion; the third hydraulic actuator may comprise a third housing (24e, 224) having a fifth port (29i, 229a) and a sixth port (29j, 229b); the control line may comprise a fifth control line (37, 37a) between the actuator pump and the fifth port and a sixth control line (38, 38a) between the actuator pump and the sixth port; the valve assembly may comprise a fifth valve (58c, 58d) in the fifth control line between the actuator pump and the fifth port configured to control flow between the actuator pump and the fifth port; and the valve assembly may comprise a sixth valve (59c, 59d) in the sixth control line between the actuator pump and the sixth port configured to control flow between the actuator pump and the sixth port; wherein alternatively actuation of the third object to be driven relative to the body portion of the mobile machine within the third range of motion may be operatively controllable by the actuator motor and the valve assembly. The third hydraulic actuator may comprise a linear hydraulic actuator (22) or a rotary hydraulic actuator (220).

The mobile machine may comprise: a tank (30) open to atmosphere; an electric charge motor (72) connected to the electric power source and configured to be supplied with a current; a charge pump (73) driven by the charge motor; the charge pump connected to the tank and connected to the hydraulic control line (35, 36) by a charge line (75, 74a, 75b, 75c, 75d, 175, 175a, 175b, 175c, 175d); and wherein a charge pressure in the charge line may be operatively controllable by the electric charge motor. The mobile machine may comprise a hydraulic release (54b, 55b, 45a, 45b) between the control line and the charge line.

The mobile machine may comprise a controller (60) that receives input signals and outputs command signals to the actuator motor to control actuation of the first object to be driven relative to the body portion of the mobile machine and the second object to be driven relative to the body portion of the mobile machine.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a representative perspective view of a first embodiment of an improved mobile machine.

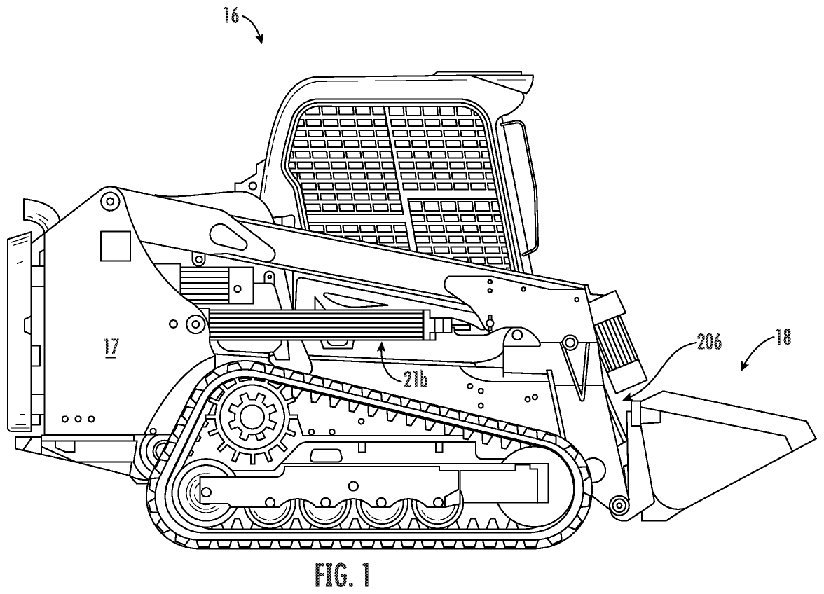

FIG. 2 is a top schematic view of the mobile machine shown in FIG. 1.

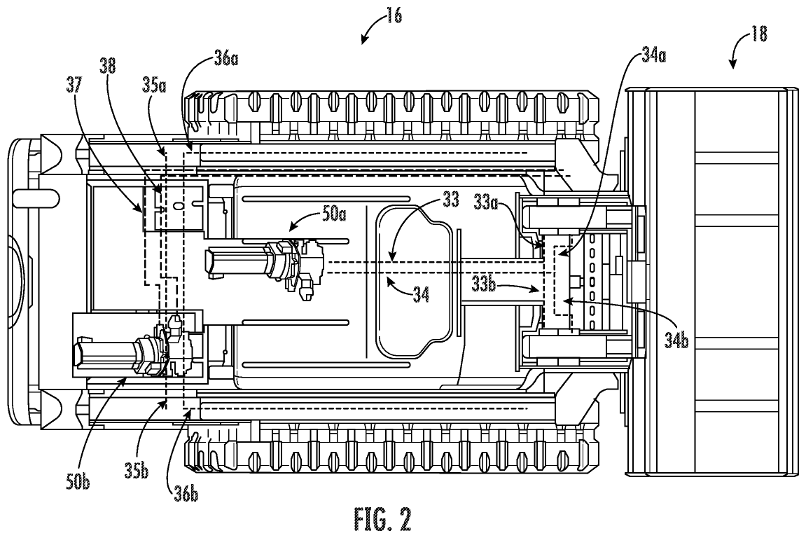

FIG. 3 is a schematic system diagram of the mobile machine electro-hydraulic actuator system shown in FIG. 2.

FIG. 4 is an alternative embodiment of the mobile machine electro-hydraulic actuator system shown in FIG. 3.

FIG. 5 is an alternative embodiment of the mobile machine electro-hydraulic actuator system shown in FIG. 4.

FIG. 6 is an alternative embodiment of the mobile machine electro-hydraulic actuator system shown in FIG. 3.

FIG. 7 is an alternative embodiment of the mobile machine electro-hydraulic actuator system shown in FIG. 6.

### DETAILED DESCRIPTION OF THE EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., crosshatching, arrangement of parts, proportion, degree, etc.) together with the specification, and are to be considered a portion of the entire written description. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

It is to be understood that the specific assemblies and systems illustrated in the attached drawings and described in the following specification are simply exemplary embodiments. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

It is to be appreciated that the present teaching is by way of example only, not by limitation. The concepts herein are not limited to use or application with a specific system or method. Thus, although the instrumentalities described herein are for the convenience of explanation, shown and described with respect to exemplary embodiments, it will be appreciated that the principles herein may be applied equally in other types of systems and methods.

Where they are used herein, the terms “first,” “second,” and so forth, do not necessarily denote any ordinal, sequential or priority relation, but are simply used to distinguish one element or set of elements more clearly from another element or set of elements, unless specified otherwise.

Referring to the drawings, an improved electric powered actuator system for a mobile machine is provided, of which a first embodiment is generally indicated at 15. In this embodiment, electric powered actuator system 15 actuates parallel tilt cylinders 20a and 20b and parallel lift cylinders 21a and 21b of bucket 18 of skid steer loader 16 relative to body 17 of skid steer loader 16. In this embodiment, electric powered actuator system 15 also provides an accessory cylinder 22 for actuating accessory implements. While actuator system 15 is shown in this embodiment actuating bucket 18, other skid steer attachments may be driven by actuation system 15, including without limitation brush cutters, bale squeezes, mowers, pallet forks, snow blowers, augers, sweepers, stump grinders, snow blowers, tree spades, dumping hoppers, tillers, and cement mixers. Thus, a variety of other work tools or attachments that may be powered by the actuation system 15 of skid steer 16. While in this embodiment the lift arm mobile machine comprises skid steer 16, other lift arm mobile machines that are generally self-propelled construction vehicles that have one or more lift arms that support and actuate attached work tools or attachments may be used, such as for example and without limitation skid steer loaders, forklifts, excavators, and tractors. Thus, system 15 may be employed in a variety of other applications, including without limitation in excavators, wheel loaders and in other mobile equipment or machines that require multiple actuation elements.

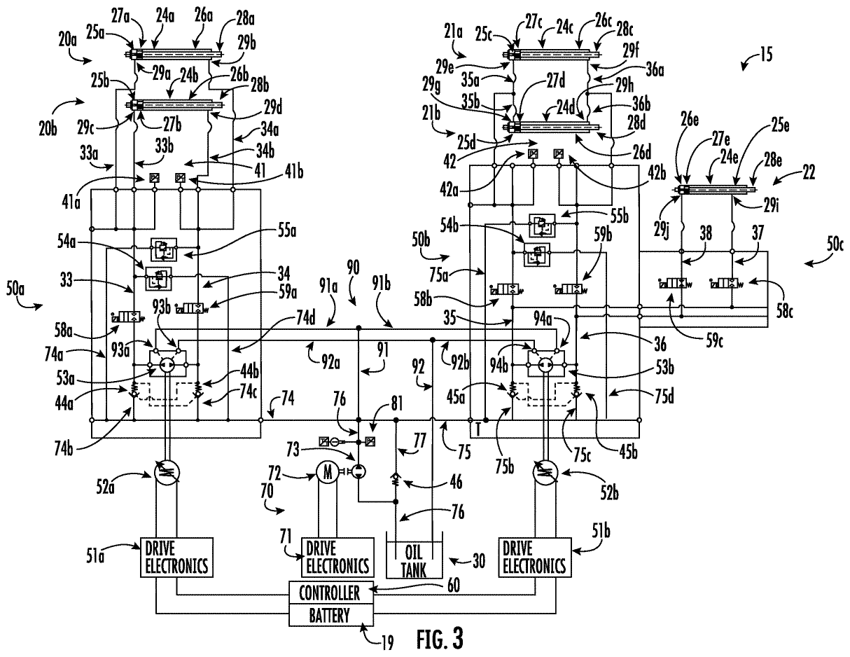

As shown in FIG. 3, actuation system 15 generally includes tilt motor pump assembly 50a, lift motor pump assembly 50b, hydraulic piston tilt assemblies 20a and 20b, hydraulic piston lift assemblies 21a and 21b, hydraulic piston auxiliary assembly 22, system fluid tank line 76 and tank 30, charge motor pump assembly 70, cooling assembly 90, and battery system 19, all supported on body 17 of skid steer 16.

Tilt motor pump assembly 50a generally includes drive electronics 51a, variable speed bidirectional electric servomotor 52a, and bidirectional or reversible pump 53a driven by motor 52a. Lift motor pump assembly 50b generally includes drive electronics 51b, variable speed bidirectional electric servomotor 52b, and bidirectional or reversible pump 53b driven by motor 52b. Charge motor pump assembly 70 generally includes drive electronics 71, variable speed bidirectional electric servomotor 72, and pump 73 driven by motor 72.

Hydraulic control lines run from motor and pump assembly 50a to each of hydraulic cylinders 20a and 20b, and from motor and pump assembly 50b to each of hydraulic cylinders 20a, 20b and 22, with control lines 33, 33a, 33b, 34, 34a and 34b feeding bucket 18 tilt cylinders 20a and 20b from pump 53a, control lines 35, 35a, 35b, 36, 36a and 36b feeding bucket 18 lift cylinders 21a and 21b from pump 53b, and control lines 37 and 38 feeding accessory implements cylinder 22 from pump 53b.

Hydraulic tank lines 74, 75 and 76 run between motor and pump assemblies 50a and 50b and tank 30, with charge pump 73 in tank line 76 between branch tank lines 74 and 75 and tank 30. Hydraulic branch tank lines 74 and 75 run between tank line 76 and motor and pump assemblies 50a and 50b, respectively, with branch tank lines 74, 74a, 74b, 74c and 74d feeding tank line 76 to tank 30 from assembly 50a and branch tank lines 75, 75a, 75b, 75c and 75d feeding tank line 76 to tank 30 from assembly 50b. Tank 30 feeds pump 73 via line 76.

Hydraulic coolant input lines 91, 91a and 91b run between tank line 76 and motor and pump assemblies 50a and 50b, with branch coolant input line 91a feeding pump 53a of assembly 50a from tank 30 via line 76, pump 73 and line 91, and branch coolant input line 91b feeding pump 53b of assembly 50b from tank 30 via line 76, pump 73 and line 91. Coolant output lines 92, 92a and 92b run between motor and pump assemblies 50a and 50b and tank 30, with branch coolant output line 92a feeding tank coolant return line 92 to tank 30 from pump 53a of assembly 50a and branch coolant output line 92b feeding tank coolant return line 92 to tank 30 from assembly 50b.

In this embodiment, motors 52a and 52b and 72 are each brushless D.C. variable-speed servo-motors that are supplied with a current via battery 19 and drive electronics 51a, 51b, and 71, respectively. Motors 52a, 52b and 72 each have an inner rotor with permanent magnets and a fixed non-rotating stator with coil windings. When current is appropriately applied through the coils of the stator, a magnetic field is induced. The magnetic field interaction between the stator and rotor generates torque which may rotate the motor output shaft. When the supplied current is of one polarity, the motor will rotate in one direction. When the supplied current supplied is of the opposite polarity, the motor will rotate in the opposite direction. Accordingly, the motor will selectively apply a torque on its output shaft in one direction about the motor axis at varying speeds and will apply a torque on its output shaft in the opposite direction about the motor axis at varying speeds. Other motors may be used as alternatives. For example, variable speed stepper motors, brush motors, and induction motors may be used as alternatives to motors 52a, 52b and 72, and unidirectional motors may be used as alternatives to motor 70. Other electric power sources may be used as alternatives to battery 19. For example, a hydrogen fuel cell electric power source may be used as an alternative.

Motor controllers 51a, 51b and 71 are connected to battery system 19 and receive power from battery system 19. System controller 60 communicates with motor controllers 51a, 51b and 71, which in turn supply a current of the appropriate magnitude and polarity to motors 52a, 52b and 72, respectively. Motor controllers 51a, 51b and 71 include drive electronics that, based on a resolver angular position feedback, generate and commutate the stator fields to vary the speed and direction of motors 52a, 52b and 72, respectively.

In this embodiment, pumps 53a and 53b are each fixed displacement bidirectional internal two-port gear pumps and pump 73 is a fixed displacement two-quadrant unidirectional internal two-port gear pump. The pumping elements, namely gears, are capable of rotating in either direction, thereby allowing hydraulic fluid to flow in either direction. This allows for oil to be added into and out of the system as the system controller closes the control loop of position or pressure. The shaft of at least one gear of each of pumps 53a, 53b and 73 is connected to the output shaft of motors 52a, 52b and 72, respectively, with the other pump gear following. The direction of flow of each of pumps 53a and 53b depends on the direction of rotation of the connected motors 52a and 52b, respectively. In addition, the speed and output of the respective pump is variable with variations in the speed of its connected motor. Other types of pumps may be used as alternatives. For example, a variable displacement pump may be used.

In this embodiment, hydraulic piston assembly 20a includes piston 27a slidably disposed within cylindrical housing 24a such that piston 27a may be driven in both directions relative to housing 24a. Piston 27a sealingly separates chamber 25a from chamber 26a. As shown, one side or port of pump 53a communicates with chamber 25a via fluid line 33 and the opposite side or port of pump 53a communicates with chamber 26a via fluid line 34. Piston 27a is connected to actuating rod 28a. Bidirectional motor 52a turns bidirectional pump 53a and bidirectional pump 53a is hydraulically connected to piston actuator 20a. Pump 53a and piston actuator 20a form a hydrostatic transmission, so as pump 53a spins in a first direction, piston 27a and rod 28a move in a first direction and as pump 53a spins in the other direction, piston 27a and rod 28a move in the other direction. Thus, piston 27a will extend or move rod 28a up when bidirectional motor 52a is rotated in a first direction, thereby rotating bidirectional pump 53a in a first direction and drawing fluid in through a pump port from line 34 and chamber 26a and out from a pump port and into line 33 and chamber 25a. Piston 27a will retract rod 28a or move to down when bidirectional motor 52a is rotated in the other direction, rotating bidirectional pump 53a in the other direction and drawing fluid in through a pump port from line 33 and chamber 25a and out from a pump port and into line 34 and chamber 26a.

Hydraulic piston assembly 20b is orientated parallel to hydraulic piston assembly 20a and is configured to operate in tandem with hydraulic piston assembly 20a. Similar to hydraulic piston assembly 20a, hydraulic piston assembly 20b includes piston 27b slidably disposed within cylindrical housing 24b such that piston 27b may be driven in both directions relative to housing 24b. Piston 27b sealingly separates chamber 25b from chamber 26b. As shown, one side or port of pump 53a communicates with chamber 25b via fluid line 33 and the opposite side or port of pump 53a communicates with chamber 26b via fluid line 34. Piston 27b is connected to actuating rod 28b. Bidirectional pump 53b is hydraulically connected to piston actuator 20b. Pump 53a and piston actuator 20b form a hydrostatic transmission, so as pump 53a spins in a first direction, piston 27b and rod 28b move in a first direction and as pump 53a spins in the other direction, piston 27b and rod 28b move in the other direction. Thus, piston 27b will extend or move rod 28b up when bidirectional motor 52a is rotated in a first direction, thereby rotating bidirectional pump 53a in a first direction and drawing fluid in through a pump port from line 34 and chamber 26b and out from a pump port and into line 33 and chamber 25b. Piston 27b will retract rod 28b or move to down when bidirectional motor 52a is rotated in the other direction, rotating bidirectional pump 53a in the other direction and drawing fluid in through a pump port from line 33 and chamber 25b and out from a pump port and into line 34 and chamber 26b.

Hydraulic manifold assembly 50a includes hydraulic brake valves 58a and 59a between pump 53a and hydraulic piston assemblies 20a and 20b. In particular, valve 58a is fluid line 33 between pump 53a and chambers 25a and 25b of hydraulic piston assemblies 20a and 20b, respectively, and valve 59a is in line 34 between pump 53a and chambers 26a and 26b of hydraulic piston assemblies 20a and 20b, respectively. Valves 58a and 59a are operatively configured to hold pistons 27a and 27b, and thereby the tilt of bucket 18, in a braked position relative to cylinders 24a and 24b. In this embodiment, valves 58a and 59a are both active valves that employ an external actuation force to open or close, rather than passive valves in which the operational state of open or closed is determined by the fluid the valve controls (e.g. a check valve). In this embodiment valves 58a and 59a are two-way two-port solenoid valves. When valves 58a and 59a are energized, the valve is held open, thereby allowing equalization of fluid pressure on each side of the valve and flow through the valve in either direction. When valves 58a and 59a are de-energized, the spring of the solenoid valve will bias it to blocked port and closed, thereby blocking flow in either direction through the valve. Thus, in the event of a power failure, valves 58a and 59a will close and maintain pressure in chambers 25a, 25b, 26a and 26b to brake pistons 27a and 27b and bucket 18 in the controlled tilt range of motion.

Hydraulic manifold assembly 50a also includes hydraulic release valves 54a and 55a between pump 53a and hydraulic piston assemblies 20a and 20b. In particular, release valve 54a is in fluid line 33 between pump 53a and chambers 25a and 25b of hydraulic piston assemblies 20a and 20b, respectively, and release valve 55a is in line 34 between pump 53a and chambers 26a and 26b of hydraulic piston assemblies 20a and 20b, respectively. Release valves 54a and 55a communicate with tank 30 via tank lines 74 and 76 and include anticavitation check valves. Release valve 54a is operatively configured to release hydraulic fluid from chambers 25a and 25b to tank 30 via tank lines 74d, 74 and 76 when the pressure in such chambers exceeds a threshold value, such as from a high shock loading of bucket 18 that could otherwise damage mobile machine 18. The check valve is in turn operatively configured to open line 34 to tank 30 via tank lines 74d, 74 and 76 and negative pressure in line 34 and chambers 26a and 26b upon sudden release of fluid and pressure from line 33. Thus, reservoir 30 is recharged and discharged, as appropriate, to accommodate the differential fluid volumes on each side of pistons 27a and 27b from a shock releasing event. Similarly, release valve 55a is operatively configured to release hydraulic fluid from chambers 26a and 26b to tank 30 and tank lines 74a, 74 and 76 when the pressure in such chambers exceeds a threshold value. The check valve is in turn operatively configured to open line 33 to tank 30 via tank lines 74a, 74 and 76 via negative pressure in line 33 and chambers 25a and 25b upon sudden release of fluid and pressure from line 34, with reservoir 30 recharged and discharged, as appropriate, to accommodate differential fluid volumes on each side of pistons 27a and 27b from a shock releasing event.

In this embodiment, hydraulic piston assembly 21a includes piston 27c slidably disposed within cylindrical housing 24c such that piston 27c may be driven in both directions relative to housing 24c. Piston 27c sealingly separates left chamber 25c from right chamber 26c. As shown, one side or port of pump 53b communicates with left chamber 25c via fluid line 35 and the opposite side or port of pump 53b communicates with right chamber 26c via fluid line 36. Piston 27c is connected to actuating rod 28c. Bidirectional motor 52b turns bidirectional pump 53b and bidirectional pump 53b is hydraulically connected to piston actuator 21a. Pump 53b and piston actuator 21a are a hydrostatic transmission, so as pump 53b spins in a first direction, piston 27c and rod 28c move in a first direction and as pump 53b spins in the other direction, piston 27c and rod 28c move in the other direction. Thus, piston 27c will extend or move rod 28c to the right when bidirectional motor 52b is rotated in a first direction, thereby rotating bidirectional pump 53b in a first direction and drawing fluid in through a pump port from line 36 and chamber 26c and out from a pump port and into line 35 and chamber 25c. Piston 27c will retract rod 28c or move to the left when bidirectional motor 52b is rotated in the other direction, rotating bidirectional pump 53b in the other direction and drawing fluid in through a pump port from line 35 and chamber 25c and out from a pump port and into line 36 and chamber 26c.

Hydraulic piston assembly 21b is orientated parallel to hydraulic piston assembly 21a and is configured to operate in tandem with hydraulic piston assembly 21a. Similar to hydraulic piston assembly 21a, hydraulic piston assembly 21b includes piston 27d slidably disposed within cylindrical housing 24d such that piston 27d may be driven in both directions relative to housing 24d. Piston 27d sealingly separates left chamber 25d from right chamber 26d. As shown, one side or port of pump 53b communicates with left chamber 25d via fluid line 35 and the opposite side or port of pump 53b communicates with right chamber 26d via fluid line 36. Piston 27d is connected to actuating rod 28d. Bidirectional motor 52b turns bidirectional pump 53b and bidirectional pump 53b is also hydraulically connected to piston actuator 21b. Pump 53b and piston actuator 21b form a hydrostatic transmission, so as pump 53b spins in a first direction, piston 27d and rod 28d move in a first direction and as pump 53b spins in the other direction, piston 27d and rod 28d move in the other direction. Thus, piston 27d will extend or move rod 28d to the right when bidirectional motor 52b is rotated in a first direction, thereby rotating bidirectional pump 53b in a first direction and drawing fluid in through a pump port from line 36 and chamber 26d and out from a pump port and into line 35 and chamber 25d. Piston 27d will retract rod 28d or move to the left when bidirectional motor 52b is rotated in the other direction, rotating bidirectional pump 53b in the other direction and drawing fluid in through a pump port from line 35 and chamber 25d and out from a pump port and into line 36 and chamber 26d.

Hydraulic manifold assembly 50b includes auxiliary and brake valves 58b and 59b between pump 53b and hydraulic piston assemblies 21a and 21b, and between hydraulic piston assemblies 21a and 21b and auxiliary fluid lines 37 and 38. Valve 58b is in fluid line 35 between pump 53b and chambers 25c and 25d of hydraulic piston assemblies 21a and 21b, and also between chambers 25c and 25d of hydraulic piston assemblies 21a and 21b and auxiliary fluid line 37. Valve 59b is in fluid line 36 between pump 53b and chambers 26c and 26d of hydraulic piston assemblies 21a and 21b, and also between chambers 26c and 26d of hydraulic piston assemblies 21a and 21b and auxiliary fluid line 38. Valves 58b and 59b are operatively configured to hydraulically isolate hydraulic piston assemblies 21a and 21b from pump 53b and to hold pistons 27c and 27d, and thereby the height of bucket 18, in a braked position relative to cylinders 24c and 24d. In this embodiment, valves 58b and 59b are both active valves that employ an external actuation force to open or close, rather than passive valves in which the operational state of open or closed is determined by the fluid the valve controls (e.g. a check valve). In this embodiment valves 58b and 59b are two-way two-port solenoid valves. When valves 58b and 59b are energized, the valve is held open, thereby allowing equalization of fluid pressure on each side of the valve and flow through the valve in either direction. When valves 58b and 59b are de-energized, the spring of the solenoid valve will bias it to blocked port and closed, thereby blocking flow in either direction through the valve. Thus, in the event of a power failure, valves 58b and 59b will close and maintain pressure in chambers 25c, 25d, 26c and 26d to brake pistons 27c and 27d and bucket 18 in the controlled lift range of motion.

Hydraulic manifold assembly 50b also includes hydraulic release valves 54b and 55b between pump 53b and hydraulic piston assemblies 21a and 21b. In particular, release valve 54b is fluid line 35 between pump 53b and chambers 25c and 25d of hydraulic piston assemblies 21a and 21b, respectively, and release valve 55b is in line 36 between pump 53b and chambers 26c and 26d of hydraulic piston assemblies 21a and 21b, respectively. Release valves 54b and 55b communicate with tank 30 and include anticavitation check valves. Release valve 54b is operatively configured to release hydraulic fluid from chambers 25c and 25d to tank 30 via tank lines 75d, 75 and 76 when the pressure in such chambers exceeds a threshold value, such as from a high shock loading of bucket 18 that could otherwise damage mobile machine 18. The check valve is in turn operatively configured to open line 36 to tank 30 via tank lines 75d, 75 and 76 and negative pressure in line 36 and chambers 26c and 26d upon sudden release of fluid and pressure from line 35. Thus, reservoir 30 is recharged and discharged, as appropriate, to accommodate the differential fluid volumes on each side of pistons 27c and 27d from a shock releasing event. Similarly, release valve 55b is operatively configured to release hydraulic fluid from chambers 26c and 26d to tank 30 via tank lines 75a, 75 and 76 when the pressure in such chambers exceeds a threshold value. The check valve is in turn operatively configured to open line 35 to tank 30 via tank lines 75a, 75 and 76 and negative pressure in line 35 and chambers 25c and 25d upon sudden release of fluid and pressure from line 36, with reservoir 30 recharged and discharged, as appropriate, to accommodate differential fluid volumes on each side of pistons 27c and 27d from a shock releasing event.

In this embodiment, accessory cylinder 22 includes piston 27e slidably disposed within cylindrical housing 24e such that piston 27e may be driven in both directions relative to housing 24e. Hydraulic manifold 50c includes hydraulic valves 58c and 59c between pump 53b and hydraulic piston assembly 22. Piston 27e sealingly separates left chamber 26e from right chamber 25e. As shown, one side or port of pump 53b communicates with right chamber 25e via fluid line 35, valve 58c and fluid line 37. The opposite side or port of pump 53b communicates with left chamber 26e via fluid line 36, valve 59c and fluid line 38. In particular, valve 58c is between fluid lines 35 and 37 and between pump 53b and chamber 25e of hydraulic piston assembly 22, and valve 59c is between fluid lines 36 and 38 and between pump 53b and chamber 26e of hydraulic piston assembly 22. Valves 58c and 59c are operatively configured to hydraulically isolate hydraulic piston assembly 22 and hold piston 27e in a braked position relative to cylinder 24e. In this embodiment, valves 58c and 59c are both active valves that employ an external actuation force to open or close, rather than passive valves in which the operational state of open or closed is determined by the fluid the valve controls (e.g. a check valve). In this embodiment valves 58c and 59c are two-way two-port solenoid valves. When valves 58c and 59c are energized, the valve is held open, thereby allowing equalization of fluid pressure on each side of the valve and flow through the valve in either direction. When valves 58c and 59c are de-energized, the spring of the solenoid valve will bias it to blocked port and closed, thereby blocking flow in either direction through the valve.

Piston 27e is connected to actuating rod 28e. Bidirectional motor 52b turns bidirectional pump 53b and bidirectional pump 53b may be hydraulically connected to piston actuator 22 by closing valves 58b and 59b and opening valves 58c and 59c. In this auxiliary configuration, pump 53b and piston actuator 22 form a hydrostatic transmission, so as pump 53b spins in a first direction, piston 27e and rod 28e move in a first direction and as pump 53b spins in the other direction, piston 27e and rod 28e move in the other direction. Thus, piston 27e will extend or move rod 28e to the right when bidirectional motor 52b is rotated in a first direction, thereby rotating bidirectional pump 53b in a first direction and drawing fluid in through a pump port from lines 37 and 35 and chamber 25e and out from a pump port and into lines 36 and 38 and chamber 26e. Piston 27e will retract rod 28e or move to the left when bidirectional motor 52b is rotated in the other direction, rotating bidirectional pump 53b in the other direction and drawing fluid in through a pump port from lines 38 and 36 and chamber 26e and out from a pump port and into lines 35 and 37 and chamber 25e.

In this embodiment, hydraulic manifold assembly 50a includes pressure sensor assembly 41, which includes pressure transducer 41a and pressure transducer 41b. Pressure transducer 41a is in line 33 between braking valve 58a and chambers 25a and 25b and is configured to sense pressure in chambers 25a and 25b, including when hydraulic brake valve 58a is closed and bucket 18 is held in a braked position within its tilt range of motion, and provides a pressure input signal to controller 60. Similarly, pressure transducer 41b is in line 34 between braking valve 59a and chambers 26a and 26b and is configured to sense pressure in chambers 26a and 26b, including when hydraulic brake valve 59a is closed and bucket 18 is held in a braked position within its tilt range of motion, and provides a pressure input signal to controller 60. Controller 60 and drive electronics 51a may thereby provide a current to motor 52a that corresponds to the sensed pressure feedback from pressure sensor 41 to remove any pressure differential between the opposite sides of hydraulic brakes 58a and 59a, respectively, and thereby reduce any jump or jerk in pistons 27a and 27b when hydraulic brake valves 58a and 59a are opened and release their hold of pistons 27a and 27b and bucket 18 from a braked tilt position.

In this embodiment, hydraulic manifold assembly 50b includes pressure sensor assembly 42, which includes pressure transducer 42a and pressure transducer 42b. Pressure transducer 42a is in line 35 between braking valve 58b and chambers 25c and 25d and is configured to sense pressure in chambers 25c and 25d, including when hydraulic brake valve 58b is closed and bucket 18 is held in a braked position within its lift range of motion, and provides a pressure input signal to controller 60. Similarly, pressure transducer 42b is in line 36 between braking valve 59b and chambers 26c and 26d and is configured to sense pressure in chambers 26c and 26d, including when hydraulic brake valve 59b is closed and bucket 18 is held in a braked position within its lift range of motion, and provides a pressure input signal to controller 60. Controller 60 and drive electronics 51b may thereby provide a current to motor 52b that corresponds to the sensed pressure feedback from pressure sensor 42 to remove any pressure differential between the opposite sides of hydraulic brakes 58b and 59b, respectively, and thereby to reduce any jump or jerk in pistons 27c and 27d when hydraulic brake valves 58b and 59b are opened and release their hold of pistons 27a and 27b and bucket 18 from a braked lift position.

Pilot operated check valves 44a and 44b are between branch tank lines 74b and 74c to tank 30 and lines 33 and 34 from pump 53a, respectively. They address volumetric differences between opposed chambers 25a, 25b and 26a, 26b. For example, when piston 27a retracts within cylinder 24a, the volume of fluid removed from collapsing chamber 25a will be greater than the volume of fluid supplied to expanding right chamber 26a because of rod 28a absent reservoir tank 30 and line 76. Similarly, pilot operated check valves 45a and 45b are between branch tank lines 75b and 75c to tank 30 and lines 35 and 36 from pump 53b to address volumetric differences between opposed chambers 25c, 25d and 26c, 26d. Thus, the side of pump 53a or 53b with low pressure will have its valve 44a or 44b, or 45a or 45b, open such that low pressure of pump 53a or 53b is connected to tank line 74 or 75, respectively.

Thus, oil reservoir or tank 30 is connected to hydraulic actuator modules 50a and 50b via fluid line 76 and branch fluid lines 74 and 75 and compensates for volumetric differences in the system and thermal oil expansion and contraction within the system. Tank 30 may be either discharged or recharged, as appropriate, to accommodate differential fluid volumes. Tank 30 is an open-to-atmosphere tank. Charge motor pump assembly 70 is operatively configured to maintain a pressure in tank lines 74 and 75, including branch tank lines 74a-d and 75a-d, that is above the atmospheric pressure of tank 30. Thus, all of tank lines 74, 74a, 74b, 74c, 74d, 75, 75a, 75b, 75c and 75d are connected to pump 73 such that they are all operatively pressurized to a threshold charge pressure. For example, and without limitation, if tank 30 is at atmospheric pressure, tanks lines 74, 74a, 74b, 74c, 74d, 75, 75a, 75b, 75c and 75d may be pressurized by assembly 70 and pump 73 to 5 bar such that the pressure in the system does not fall to atmospheric during operation of system 15.

In this embodiment, hydraulic charge assembly 70 also includes pressure transducer 81. Pressure transducer 81 is in line 76 between pump 73 and lines 74 and 75 to hydraulic manifold modules 50a and 50b, respectively, and is configured to sense pressure in tank lines 74 and 75 from hydraulic manifold modules 50a and 50b and provides a pressure input signal to controller 60. Controller 60 and drive electronics 71 may thereby provide a current to motor 72 that corresponds to the sensed pressure feedback from pressure sensor 81 to close the loop on the desired charge pressure from pump 73 to tank lines 74, 74a, 74b, 74c, 74d, 75, 75a, 75b, 75c and 75d with hydraulic manifold assemblies 50a and 50b to thereby reduce any cavitation that might otherwise result from pressure drops in the system below atmospheric pressure during operation.

Pilot operated check valve 46 is in line 77 between tank lines 74 and 75 of hydraulic manifold modules 50a and 50b and tank 30 parallel to tank line 76. Valve 46 is a relief valve for pump 73 and provides over-pressure protection to avoid the pressure in tank lines 74, 74a, 74b, 74c, 74d, 75, 75a, 75b, 75c and 75d suddenly exceeding a threshold maximum pressure.

Controller 60 receives drive commands, such as from joystick controls, and feedback from sensors in the system, such as the position of pistons 27a and 27b monitored via position transducers and/or pressure from transducers 41, 42 and 81, and provides commands to drive electronics 51a, 51b and 71 and/or valves 58a-c and 59a-c accordingly. Motor controller 60 supplies current command signals to power stages 51a, 51b and 71, which in turn supply current of the appropriate magnitude and polarity to motors 52a, 52b and 72, respectively, with such commands based in part on angular position feedback from resolvers and pressure transducers. Variable speed bidirectional motors 52a and 52b and pumps 53a and 53b control the speed and force of pistons 27a-e, and in turn rods 28a-e, by changing the flow and pressure acting on pistons 27a-e, respectively, by looking at position and pressure feedback and then closing the control loop by adjusting the speed and direction of motors 52a and 52b, respectively. Additional and/or alternative pressure and/or position sensors may be used in system 15 and signals fed back to controller 60.

System 15 may include cooling circuit 90 configured to cool motor pump assemblies 50a and 50b. As shown, coolant input lines 91, 91a and 91b run between tank line 76 and motor and pump assemblies 50a and 50b. Coolant input line 91a feeds coolant input 93a of the casing of pump 53a of assembly 50a from tank 30 via line 76 and line 91. Input line 91a is thereby charged by pump motor assembly 70. Similarly, coolant input line 91b feeds coolant input 94a of the casing of pump 53b of assembly 50b from tank 30 via line 76 and line 91. Input line 91a is thereby charged by pump motor assembly 70. Coolant output lines 92, 92a and 92b run between motor and pump assemblies 50a and 50b and tank 30. Coolant output line 92a feeds tank coolant return line 92 to tank 30 from case drain 93b of pump 53a of assembly 50a. Similarly, coolant output line 92b feeds tank coolant return line 92 to tank 30 from case drain 94b of pump 53b of assembly 50b. Accordingly, cooling circuit 90 is operatively configured to use charge pump 73 to circulate fluid from tank 30 via lines 91 and 91a through the casing of pump 53a, where it absorbs heat from pump 53a, and to return such fluid via lines 92a and 92 to tank 30, and to circulate fluid from tank 30 via lines 91 and 91b through the casing of pump 53b, where it absorbs heat from pump 53b, and to return such fluid via lines 92b and 92 to tank 30. A heat exchanger may be provided in line 92 and/or tank 30 to cool the fluid circulated through pumps 53a and 53b if desired. Thus, actuator system 15 may include cooling functionality.

Power source 19 may include a regenerative power circuit to take advantage of a regenerative mode in which motors 52a, 52b and/or 72 are controlled to operate as a generator in a power generation mode when external regenerative forces, such as gravity loads, on hydraulic assemblies 50a, 50b or 50c exceed a threshold drive pressure differential of pumps 53a, 53b, or 73 and drive torque of motors 52a, 52b or 72, respectively. When bucket 18 and/or other accessories of skid steer 16 need to absorb gravitational forces and impact forces, each of motors 52a, 52b and 72 may be configured to operate as electric generators that convert torque generated from such forces on the system into electricity that is stored in battery storage 19. For example, the effects of gravity when bucket 18 is raised will generate a force on pistons 27c and 27d of cylinders 21a and 21b, which in turn produces pressure on pump 53b when brakes 58b and 59b are not activated, which in turn produces a torque on the shaft of servomotor 52b. Under these conditions and in the regenerative mode, electric motor 52b is configured to act as an electric generator. Regenerative power stage 51b and motor controller 60 detect the armature current generated by motor 52b in this capacity and transfers such current of the appropriate magnitude and polarity of motor 52b into battery 19. Thus, actuator system 15 may include regenerative energy functionality.

Actuation system 15 provides a number of benefits. With system 15 a mobile machine may be operated with an open-to-atmosphere tank that can be filled conventionally by pouring hydraulic oil into the open-to-atmosphere tank rather than having to employ a pressurized bladder tank which requires a complex bleed process. Mobil machine auxiliary accessories like jack hammers and augers can be connected directly to system 15 even if air is introduced from the accessory as the introduced air has a path out of the system through the open-to-atmosphere tank. For unequal area cylinders that require one side of the cylinder to be metered by the actuator pump and the other side of unequal area to draw oil from the tank, and where the lines between the actuator pump and the cylinders are restrictive and susceptible to cylinder cavitation, system 15 is operatively configured to charge the tank lines to a desired low charge pressure and thereby overcome the cavitation. The charging pump allows system 15 to be employed in an environment with long hydraulic lines and an open-to-atmosphere tank. System 15 also allows a single electrohydrostatic power unit to be used sequentially on several different actuators and auxiliary equipment. The sequencing valves in system 15 allow one electro hydrostatic power unit to run multiple cylinders sequentially. In system 15, regenerative power from gravity loads can be transferred back to battery 19. System 15 absorbs high shock loading and extreme impacts to bucket 18. System 15 has high energy efficiency that minimizes the size of battery pack 19. System 15 has the ability to manage heat from a harsh duty cycle. System 15 does not result in cylinder drop when going from cylinder lock to unlock under load conditions. System 15 can provide a high dynamic response of at least 30 milliseconds step response and at least 80 Hz frequency response to allow for autonomous operation. System 15 does not use proportional valves to meter flow between the actuator pump and the hydraulic actuator and instead a motor through a pump hydrostatic transmission controls the flow to the actuator, which avoids the high losses from fixed displacement pumps which run proportional spool and body valves.

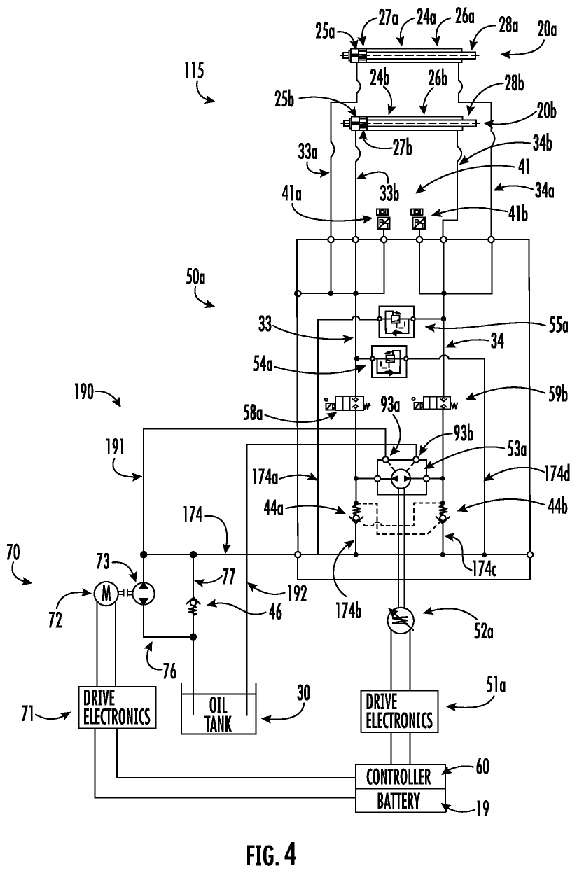

Referring now to FIG. 4, a single unit motor pump assembly embodiment of a electric powered actuator system for a mobile machine is generally indicated at 115. As in system 15 shown in FIG. 3, in this embodiment, electric powered actuator system 115 actuates parallel cylinders 20a and 20b and generally includes motor pump assembly 50a, system fluid tank 30, charge motor pump assembly 70, and battery system 19, all configured to be supported on the body of a mobile machine. However, this embodiment does not include motor pump assembly 50b, hydraulic piston assemblies 21a and 21b, or hydraulic piston auxiliary assembly 22. Thus, as shown, hydraulic control lines 33, 33a, 33b, 34, 34a and 34b feed cylinders 20a and 20b from pump 53a, tank lines 174, 174a, 174b, 174c and 174d feed tank line 76 to tank 30 from assembly 50a, coolant input line 191 feeds pump 53a of assembly 50a from tank 30 via line 76 and pump 73, and coolant output line 192 feeds tank 30 from pump 53a of assembly 50a.

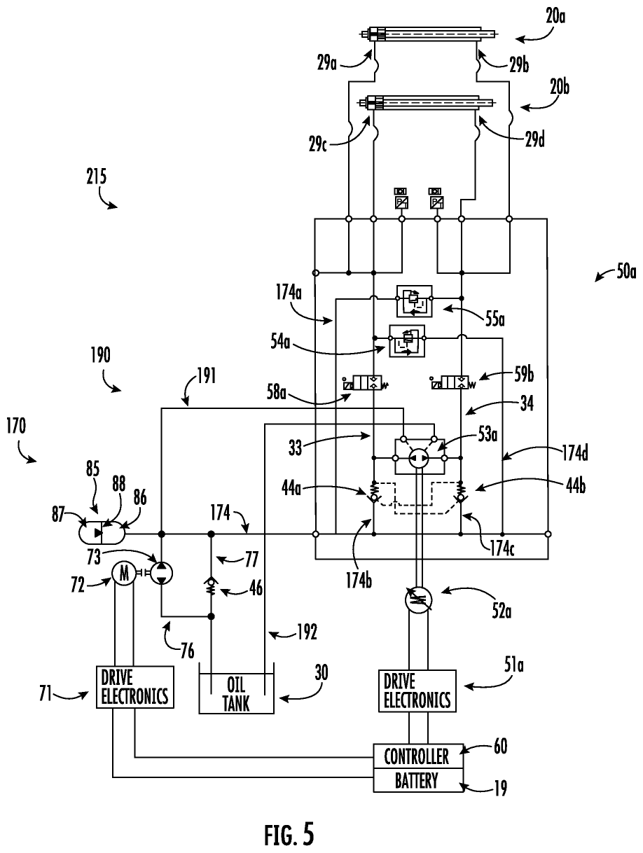

Referring now to FIG. 5, an alternative single unit motor pump assembly embodiment of an electric powered actuator system for a mobile machine is generally indicated at 215. As in system 115 shown in FIG. 4, electric powered actuator system 215 actuates parallel cylinders 20a and 20b and generally includes tilt motor pump assembly 50a, system fluid tank 30, cooling assembly 190, and battery system 19, all configured to be supported on the body of a mobile machine. However, in this embodiment, besides drive electronics 71, variable speed bidirectional electric servomotor 72, and pump 73 driven by motor 72, charge motor pump assembly 170 includes hydraulic accumulator 85.

As shown, hydraulic accumulator 85 is a pressure storage reservoir and in this embodiment comprises a compressed gas or hydro-pneumatic bladder type accumulator having two variable volume chambers 86 and 87 separated by elastomeric bladder or diaphragm 88. Accumulator 85 is provided in line 174 between charge pump 73 and hydraulic manifold assembly 50a with chamber 86 containing hydraulic fluid and open to hydraulic line 174 and chamber 87 containing an inert gas under a selected base charge pressure. Accumulator 85 maintains a base pressure in tank lines 174, 174a, 174b, 174c and 174d when there are slight reductions without charge motor 72 and pump 73 needing to be cycled on and off. Accumulator 85 also maintains such base pressure in coolant input line 191. Thus, for example and without limitation, chamber 87 and bladder 88 may be precharged to 2 bar of pressure and motor 72 and pump 73 may be controlled to provide 4-6 bar of pressure, in which case drops of 2 bar or less of pressure in hydraulic manifold assembly 50a of system 215 are compensated by accumulator 85 without the need to cycle on charge motor 72 and pump 73. Thus, accumulator 85 is used to overcome pressure losses in hydraulic manifold system 50b up to a given threshold without having to run charge motor 72 and pump 73. Other types of hydraulic compensator may be used as alternatives, including without limitation piston type or spring type accumulators.

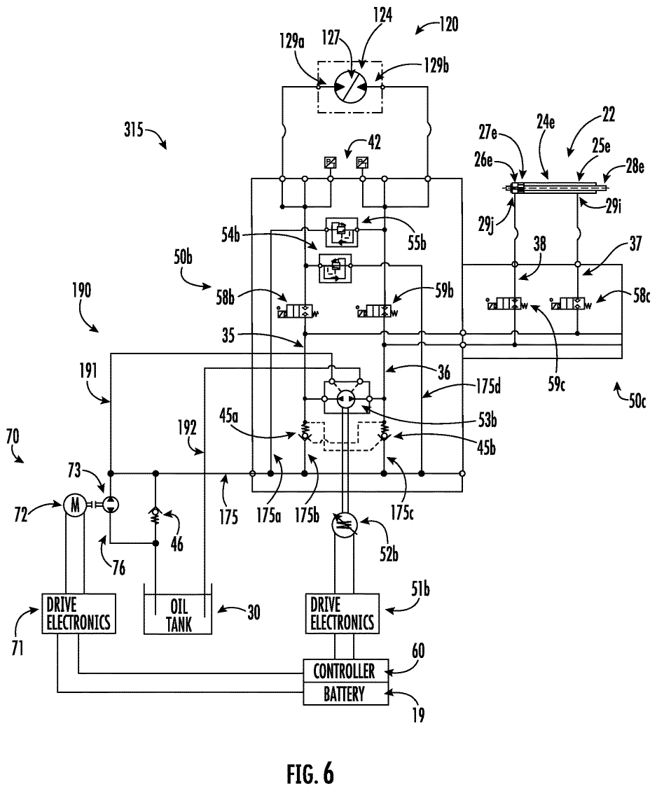

Referring now to FIG. 6, a single unit with single auxiliary motor pump assembly embodiment of an electric powered actuator system for a mobile machine is generally indicated at 315. As in system 15 shown in FIG. 3, in this embodiment actuation system 315 generally includes motor pump assembly 50b, hydraulic piston auxiliary assembly 22, system fluid tank 30, charge motor pump assembly 70, and battery system 19, all configured to be supported on the body of a mobile machine. However, this embodiment does not include motor pump assembly 50a and hydraulic piston lift assemblies 20a and 20b, and in this embodiment motor pump assembly 50b actuates hydraulic motor 120 and not hydraulic piston lift assemblies 21a and 21b. Thus, as shown, control lines 35 and 36 feed hydraulic motor 120 from pump 53b, hydraulic tank lines 175, 175a, 175b, 175c and 175d feed tank line 76 to tank 30 from assembly 50b, coolant input line 191 feeds pump 53b of assembly 50b from tank 30 via line 76 and pump 73, and coolant output line 192 feeds tank 30 from pump 53b of assembly 50b.

Bidirectional motor 52b turns bidirectional pump 53b and bidirectional pump 53b may be hydraulically connected to hydraulic motor 120 by closing each of valves 58c and 59c and by opening valves 58b and 59b. In this auxiliary configuration, pump 53b and hydraulic motor 120 form a hydrostatic transmission, so as pump 53b spins in a first direction, rotor 127 rotates in a first direction and as pump 53b spins in the other direction, rotor 127 rotates in the other direction. Thus, rotor 127 will rotate in a first direction when bidirectional motor 52b is rotated in a first direction, thereby rotating bidirectional pump 53b in a first direction and drawing fluid in from line 35 and motor port 129a and out into line 36 and motor port 129b. Rotor 127 will rotate in a second direction when bidirectional motor 52b is rotated in the other direction, rotating bidirectional pump 53b in the other direction and drawing fluid in from line 36 and motor port 129b and out into line 35 and motor port 129a.

In this embodiment, hydraulic motor 120 is a vane-type hydraulic motor having centrically supported rotor 127 with radially extending vanes that rotate in a pump ring when driven by pressurized fluid provided by pump 53b to port 129a or port 129b. The vanes may have variable lengths and may be biased to maintain contact with the pump ring as they rotate. When fluid is driven from the inlet of the motor to the outlet of the motor, the vanes attached to the motor rotor are rotationally driven by the fluid.

Other types of hydraulic motors may be used as alternatives, including without limitation radial-piston type hydraulic motors, axial-piston type hydraulic motors, and gear-type hydraulic motors in which hydraulic pressure is transformed into torque. For example, and without limitation, a radial-piston type hydraulic motor may be employed. Such a motor may comprise a plurality of radially positioned pistons disposed in cylinders in a cylinder block that is connected to an output shaft and rotates relative to a cam. Hydraulic fluid from pump 53b is fed to each cylinder and piston via a control journal having ports connected to lines 36 and 36, respectively, to produce rotational movement of the output shaft.

Bidirectional motor 52b turns bidirectional pump 53b and bidirectional pump 53b may be hydraulically connected to piston actuator 22 by closing each of valves 58b and 59b, and opening valves 58c and 59c. Thus, piston 27e will extend or move rod 28e to the right when bidirectional motor 52b is rotated in a first direction, thereby rotating bidirectional pump 53b in a first direction and drawing fluid in through a pump port from lines 37 and 35 and chamber 25e and out from a pump port and into lines 36 and 38 and chamber 26e. Piston 27e will retract rod 28e or move to the left when bidirectional motor 52b is rotated in the other direction, rotating bidirectional pump 53b in the other direction and drawing fluid in through a pump port from lines 38 and 36 and chamber 26e and out from a pump port and into lines 35 and 37 and chamber 25e.

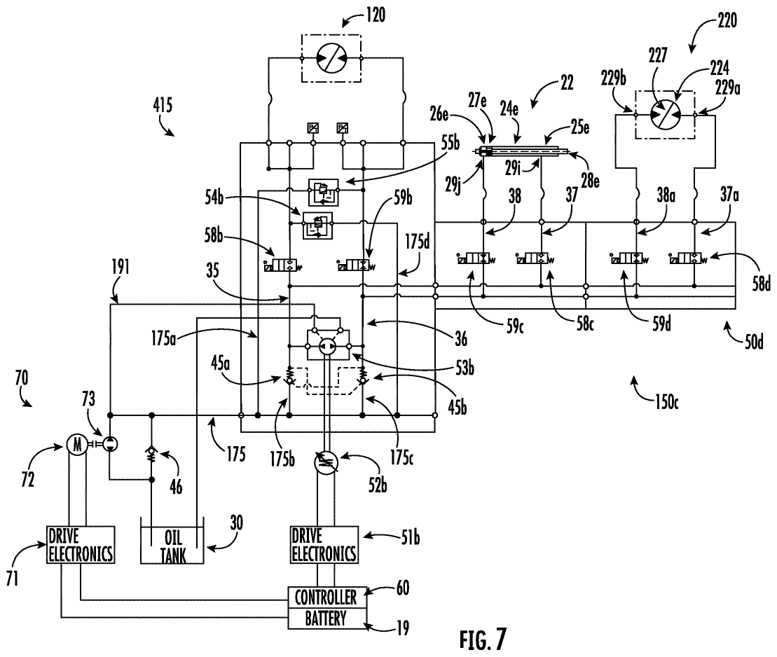

Referring now to FIG. 7, an alternative single unit with dual auxiliary motor pump assembly embodiment of an electric powered actuator system for a mobile machine is generally indicated at 415. As in system 315 shown in FIG. 6, in this embodiment electric powered actuation system 415 actuates hydraulic motor 120 and generally includes motor pump assembly 50b, system fluid tank 30, cooling assembly 190, charge motor pump assembly 70, and battery system 19, all configured to be supported on the body of a mobile machine. However, in this embodiment motor pump assembly 50b is configured to actuate auxiliary hydraulic motor 220 in addition to hydraulic piston auxiliary assembly 22. Thus, as shown, control lines 35 and 36 feed hydraulic motor 120 from pump 53b, hydraulic tank lines 175, 175a, 175b, 175c and 175d feed tank line 76 to tank 30 from assembly 50b, coolant input line 191 feeds pump 53b of assembly 50b from tank 30 via line 76 and pump 73, and coolant output line 192 feeds tank 30 from pump 53b of assembly 50b.

Hydraulic manifold 50d includes hydraulic valves 58d and 59d between pump 53b and hydraulic motor 220. As shown, one side or port of pump 53b communicates with port 229a of hydraulic motor 220 via fluid line 35, valve 58d and fluid line 37a. The opposite side or port of pump 53b communicates with port 229b of hydraulic motor 220 via fluid line 36, valve 59d and fluid line 38a. In particular, valve 58d is between fluid lines 35 and 37a and between pump 53b and port 229a of hydraulic motor 220, and valve 59d is between fluid lines 36 and 38a and between pump 53b and port 229b of hydraulic motor 220. Valves 58d and 59d are operatively configured to hydraulically isolate hydraulic motor 220 and hold rotor 227 in a braked position. In this embodiment, valves 58d and 59d are both active valves that employ an external actuation force to open or close, rather than passive valves in which the operational state of open or closed is determined by the fluid the valve controls (e.g. a check valve). In this embodiment valves 58d and 59d are two-way two-port solenoid valves. When valves 58d and 59d are energized, the valve is held open, thereby allowing equalization of fluid pressure on each side of the valve and flow through the valve in either direction. When valves 58d and 59d are de-energized, the spring of the solenoid valve will bias it to blocked port and closed, thereby blocking flow in either direction through the valve

Bidirectional motor 52b turns bidirectional pump 53b and bidirectional pump 53b may be hydraulically connected to hydraulic motor 120 by closing each of valves 58c, 59c, 59d and 59d, and by opening valves 58b and 59b. As in system 315 shown in FIG. 6, as pump 53b spins in a first direction, rotor 127 rotates in a first direction and as pump 53b spins in the other direction, rotor 127 rotates in the other direction. Thus, rotor 127 will rotate in a first direction when bidirectional motor 52b is rotated in a first direction, thereby rotating bidirectional pump 53b in a first direction and drawing fluid in from line 35 and motor port 129a and out into line 36 and motor port 129b. Rotor 127 will rotate in a second direction when bidirectional motor 52b is rotated in the other direction, rotating bidirectional pump 53b in the other direction and drawing fluid in from line 36 and motor port 129b and out into line 35 and motor port 129a.

Bidirectional motor 52b turns bidirectional pump 53b and bidirectional pump 53b may be hydraulically connected to auxiliary piston actuator 22 by closing each of valves 58b, 59b, 58d and 59d, and opening valves 58c and 59c. In this first auxiliary configuration, pump 53b and auxiliary piston actuator 22 form a hydrostatic transmission. Thus, as in system 315 shown in FIG. 6, piston 27e will extend or move rod 28e to the right when bidirectional motor 52b is rotated in a first direction, thereby rotating bidirectional pump 53b in a first direction and drawing fluid in through a pump port from lines 37 and 35 and chamber 25e and out from a pump port and into lines 36 and 38 and chamber 26e. Piston 27e will retract rod 28e or move to the left when bidirectional motor 52b is rotated in the other direction, rotating bidirectional pump 53b in the other direction and drawing fluid in through a pump port from lines 38 and 36 and chamber 26e and out from a pump port and into lines 35 and 37 and chamber 25e.

In this embodiment, hydraulic motor 220 is also a vane-type hydraulic motor having centrically supported rotor 227 with radially extending vanes that rotate in a pump ring when driven by pressurized fluid provided by pump 53b to port 229a or port 229b. The vanes may have variable lengths and may be biased to maintain contact with the pump ring as they rotate. When fluid is driven from the inlet of the motor to the outlet of the motor, the vanes attached to the motor rotor are rotationally driven by the fluid. As with hydraulic motor 120, other types of hydraulic motors may be used as alternatives, including without limitation radial-piston type hydraulic motors, axial-piston type hydraulic motors, and gear-type hydraulic motors in which hydraulic pressure is transformed into torque.

Bidirectional motor 52b turns bidirectional pump 53b and bidirectional pump 53b may be hydraulically connected to hydraulic motor 220 by closing each of valves 58b, 59b, 58c and 59c, and by opening valves 58d and 59d. In this second auxiliary configuration, pump 53b and hydraulic motor 220 form a hydrostatic transmission, so as pump 53b spins in a first direction, rotor 227 rotates in a first direction and as pump 53b spins in the other direction, rotor 227 rotates in the other direction. Thus, rotor 227 will rotate in a first direction when bidirectional motor 52b is rotated in a first direction, thereby rotating bidirectional pump 53b in a first direction and drawing fluid in from lines 37a and 35 and motor port 229a and out into lines 36 and 38a and motor port 229b. Rotor 127 will rotate in a second direction when bidirectional motor 52b is rotated in the other direction, rotating bidirectional pump 53b in the other direction and drawing fluid in from lines 38a and 36 and motor port 229b and out into lines 35 and 37a and motor port 229a.

It should be appreciated that certain features of the system, which are, for clarity, described in the context of separate embodiments, may also be provided in combination in a single embodiment. Conversely, various features, which are, for brevity, described in the context of a single embodiment, may also be provided separately or in any suitable combination. While various embodiments have been described in detail above, it should be understood that they have been presented by way of example, and not limitation. While the presently preferred form of an improved electric powered actuator system for mobile machines has been shown and described, and several modifications thereof discussed, persons skilled in this art will readily appreciate that various additional changes and modifications may be made without departing from the scope of the invention, as defined and differentiated by the claims.

1. A mobile machine comprising:
an object configured to be driven relative to a body portion of said mobile machine;
an electric power source;
an electric actuator motor connected to said electric power source and configured to be supplied with a current;
an actuator pump driven by said actuator motor;
a hydraulic actuator connected said actuator pump by a hydraulic control line;
said hydraulic actuator configured to actuate said object to be driven relative to said mobile machine within a range of motion;
a tank open to atmosphere;
an electric charge motor connected to said electric power source and configured to be supplied with a current;
a charge pump driven by said charge motor;
said charge pump connected to said tank and connected to said hydraulic control line by a charge line;
a controller that receives input signals and outputs command signals to said electric charge motor;
a pressure sensor configured to sense said charge pressure of said charge line and to provide a charge pressure input signal to said controller;
wherein actuation of said object to be driven relative to said body portion of said mobile machine within said range of motion is operatively controllable by said actuator motor; and
wherein said electric charge motor is operatively controlled by said controller based on said charge pressure input signal so as to operatively maintain a charge pressure in said charge line.

2. The mobile machine set forth in claim 1, wherein:
said hydraulic actuator comprises a housing having a first hydraulic port and a second hydraulic port;
said control line comprises a first control line between said actuator pump and said first port and a second control line between said actuator pump and said second port; and
said charge line is connected to said first control line and said second control line.

3. (canceled)

4. The mobile machine set forth in claim 1, wherein:
said hydraulic actuator comprises a linear hydraulic actuator;
said housing comprises a first hydraulic chamber and a second hydraulic chamber;
said first control line is between said actuator pump and said first chamber and said second control line is between said actuator pump and said second chamber;
said linear hydraulic actuator comprises a hydraulic piston between said first hydraulic chamber and said second hydraulic chamber and an actuating rod connected to said piston and configured to translate along an axis with movement of said piston relative to said housing; and
one of said housing or said actuating rod is connected to said mobile machine and the other of said housing or said actuating rod is connected to said object to be driven.

5. The mobile machine set forth in claim 1, wherein:
said hydraulic actuator comprises a rotary hydraulic actuator;
said rotary hydraulic actuator comprises a hydraulic motor:
said hydraulic motor comprises a hydraulic rotary element between said first and second ports of said housing and an actuating shaft connected to said rotary element and configured to rotate about an axis with movement of said rotary element relative to said housing; and
one of said housing or said actuating shaft is connected to said mobile machine and the other of said housing or said actuating shaft is connected to said object to be driven.

6. (canceled)

7. (canceled)

8. The mobile machine set forth in claim 2, comprising a hydraulic release between said control line and said charge line and between said actuator pump and said hydraulic actuator and said hydraulic release is operatively configured to release hydraulic fluid from said first control line or said second control line when a control pressure in said first control line or said second control line exceeds a threshold value.

9. The mobile machine set forth in claim 8, wherein said hydraulic release comprises:
a first release valve between said first hydraulic port and said actuator pump and between said first control line and said charge line;
a second release valve between said second hydraulic port and said actuator pump and between said second control line and said charge line;
a first check valve between said first hydraulic port and said second release valve; and
a second check valve between said second hydraulic port and said first release valve.

10. (canceled)

11. The mobile machine set forth in claim 8, comprising a first check valve between said first control line and said charge line and a second check valve between said second control line and said charge line.

12. The mobile machine set forth in claim 2, comprising:
a first valve between said first control line and said charge line;
a second valve between said second control line and said charge line;
a third valve between said first control line and said charge line;
a fourth valve between said second control line and said charge line.

13. A mobile machine comprising:
an object configured to be driven relative to a body portion of said mobile machine;
an electric power source;
an electric actuator motor connected to said electric power source and configured to be supplied with a current;
an actuator pump driven by said actuator motor;
a hydraulic actuator connected said actuator pump by a hydraulic control line;
said hydraulic actuator configured to actuate said object to be driven relative to said mobile machine within a range of motion;
a tank open to atmosphere;
an electric charge motor connected to said electric power source and configured to be supplied with a current;
a charge pump driven by said charge motor;
said charge pump connected to said tank and connected to said hydraulic control line by a charge line;
a hydraulic accumulator connected to said charge line between said charge pump and said hydraulic control line; and
wherein a base pressure in said charge line is operatively controllable by said hydraulic accumulator;
wherein actuation of said object to be driven relative to said body portion of said mobile machine within said range of motion is operatively controllable by said actuator motor; and
wherein a charge pressure in said charge line is operatively controllable by said electric charge motor.

14. The mobile machine set forth in claim 13, wherein said hydraulic accumulator is selected from a group consisting of a diaphragm type accumulator, a piston type accumulator, and a spring type accumulator.

15. The mobile machine set forth in claim 1, comprising:
a coolant input line connected to said actuator pump and connected to said charge line between said charge pump and said hydraulic control line; and
a coolant output line connected to said actuator pump and connected to said tank.

16. The mobile machine set forth in claim 1, comprising a relief valve connected to said charge line between said charge pump and said hydraulic control line and connected to said tank.

17. (canceled)

18. (canceled)

19. (canceled)

20. (canceled)

21. The mobile machine set forth in claim 1, comprising:
a second electric actuator motor connected to said electric power source and configured to be supplied with a current;
a second pump driven by said second actuator motor;
a second hydraulic actuator connected to said second pump by a second hydraulic control line;
said second hydraulic actuator configured to actuate a second object to be driven relative to said mobile machine within a second range of motion;
said charge pump connected to said second hydraulic control line by said charge line; and
wherein actuation of said second object to be driven relative to said body portion of said mobile machine within said second range of motion is operatively controllable by said second actuator motor and powered via said electric power source.

22. The mobile machine set forth in claim 21, wherein said range of motion comprises rotational motion about a tilt axis and said second range of motion comprises translational motion along a lift axis.

23. (canceled)

24. (canceled)

25. (canceled)

26. (canceled)

27. (canceled)

28. A mobile machine comprising:
an electric power source;
an electric actuator motor connected to said electric power source and configured to be supplied with a current;
an actuator pump driven by said actuator motor;
a first hydraulic actuator connected to said actuator pump;
said first hydraulic actuator configured to actuate a first object to be driven relative to said mobile machine within a first range of motion;
a second hydraulic actuator connected to said actuator pump;
said second hydraulic actuator configured to actuate a second object to be driven relative to said mobile machine within a second range of motion;
a hydraulic control line between said actuator pump and both said first hydraulic actuator and said second hydraulic actuator; and
a valve assembly in said hydraulic control line between said actuator pump and each of said first and second hydraulic actuators and configured to control flow between said actuator pump and each of said first and second hydraulic actuators;
wherein actuation of said first object to be driven relative to said body portion of said mobile machine within said first range of motion is operatively controllable by said actuator motor and said valve assembly and alternatively actuation of said second object to be driven relative to said body portion of said mobile machine within said second range of motion is operatively controllable by said actuator motor and said valve assembly.

29. The mobile machine set forth in claim 28, wherein said valve assembly comprises a four way valve.

30. The mobile machine set forth in claim 28, wherein:
said first hydraulic actuator comprises a first housing having a first port and a second port;
said control line comprises a first control line between said actuator pump and said first port and a second control line between said actuator pump and said second port;
said valve assembly comprises a first valve in said first control line between said actuator pump and said first port configured to control flow between said actuator pump and said first port;
said valve assembly comprises a second valve in said second control line between said actuator pump and said second port configured to control flow between said actuator pump and said second port;
said second hydraulic actuator comprises a second housing having a third port and a fourth port;
said control line comprises a third control line between said actuator pump and said third port and a fourth control line between said actuator pump and said fourth port;
said valve assembly comprises a third valve in said third control line between said actuator pump and said third port configured to control flow between said actuator pump and said third port; and
said valve assembly comprises a fourth valve in said fourth control line between said actuator pump and said fourth port configured to control flow between said actuator pump and said fourth port.

31. (canceled)

32. The mobile machine set forth in claim 30, wherein:
said first hydraulic actuator comprises a linear hydraulic actuator;
said first housing comprises a first hydraulic chamber and a second hydraulic chamber;
said first control line is between said actuator pump and said first chamber and said second control line is between said actuator pump and said second chamber;
said first linear hydraulic actuator comprises a first hydraulic piston between said first hydraulic chamber and said second hydraulic chamber and an actuating rod connected to said piston and configured to translate along an axis with movement of said piston relative to said housing;
one of said housing or said actuating rod is connected to said mobile machine and the other of said housing or said actuating rod is connected to said object to be driven;
said second hydraulic actuator comprises a rotary hydraulic actuator and said rotary hydraulic actuator comprises a hydraulic motor: and
said hydraulic motor comprises a hydraulic rotary element between said third and fourth ports of said second housing and an actuating shaft connected to said rotary element and configured to rotate about an axis with movement of said rotary element relative to said housing; and
one of said second housing or said actuating shaft is connected to said mobile machine and the other of said housing or said actuating shaft is connected to said object to be driven.

33. (canceled)

34. (canceled)

35. (canceled)

36. The mobile machine set forth in claim 30, comprising:
a third hydraulic actuator connected to said actuator pump;
said third hydraulic actuator configured to actuate a third object to be driven relative to said mobile machine within a third range of motion;
said third hydraulic actuator comprising a third housing having a fifth port and a sixth port;
said control line comprising a fifth control line between said actuator pump and said fifth port and a sixth control line between said actuator pump and said sixth port;
said valve assembly comprises a fifth valve in said fifth control line between said actuator pump and said fifth port configured to control flow between said actuator pump and said fifth port; and
said valve assembly comprises a sixth valve in said sixth control line between said actuator pump and said sixth port configured to control flow between said actuator pump and said sixth port;
wherein alternatively actuation of said third object to be driven relative to said body portion of said mobile machine within said third range of motion is operatively controllable by said actuator motor and said valve assembly.

37. (canceled)

38. The mobile machine set forth in claim 28, comprising:
a tank open to atmosphere;
an electric charge motor connected to said electric power source and configured to be supplied with a current;
a charge pump driven by said charge motor;
said charge pump connected to said tank and connected to said hydraulic control line by a charge line; and
wherein a charge pressure in said charge line is operatively controllable by said electric charge motor.

39. The mobile machine set forth in claim 38, comprising a hydraulic release between said control line and said charge line.

40. The mobile machine set forth in claim 28, comprising a controller that receives input signals and outputs command signals to said actuator motor to control actuation of said first object to be driven relative to said body portion of said mobile machine and said second object to be driven relative to said body portion of said mobile machine.
